(19) United States
(12) Patent Application Publication
(10) Pub. No.: US 2010/0112345 A1
(43) Pub. Date: May 6, 2010

(54) Protective coating for adhesive tape rolls

(76) Inventors: Marco Sieber, Horw (CH); Reto Sieber, Sigigen (CH)

Correspondence Address: FOLEY & LARDNER LLP, 111 HUNTINGTON AVENUE, 26TH FLOOR, BOSTON, MA, 02199-7610, US

(21) Appl. No.: 12/608,129

(22) Filed: Oct. 29, 2009

(30) Foreign Application Priority Data
Oct. 30, 2008 (DE) 10 2008 054 030.7

(51) Int. Cl. C09J 7/00; B05D 3/02; B05D 3/06; B05D 3/00; B05D 1/02

(52) U.S. Cl. 428/343; 427/385.5; 427/387; 427/553; 427/551; 427/398.3; 427/427; 427/427.4

(57) ABSTRACT

The invention relates to a method for the side protection of rolls of adhesive tape, in which a non-self-adhesive coating is applied to the side face of the adhesive tape roll. Coating material used is a varnish, polymer dispersion, wax or a powder, e.g. talc.

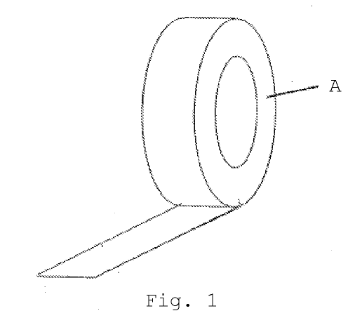

### RELATED APPLICATIONS

This application claims priority under 35 U.S.C. 119 (a)-(d) the German Application No. DE 10 2008 054 030.7, filed Oct. 20, 2008, the entire teachings of which are incorporated herein by reference.

### FIELD OF THE INVENTION

The present invention relates to a method for the side protection of rolls of adhesive tape, in which a non-self-adhesive coating is applied as protection to the side faces of the adhesive tape rolls, and also relates to the adhesive tape rolls obtained therewith.

### BACKGROUND

In general there are rolls of adhesive tape which are one-sidedly or two-sidedly self-adhesive. Adhesive tape rolls of this kind may have on the layer of adhesive an adhesive-repellent covering, what is called a release liner made of siliconized paper or siliconized film, or they are wound up on themselves without release liners. When the adhesive tape roll is employed, the release liner is peeled off and discarded. Single-sidedly adhesive tapes additionally have a backing material, which in the processed state constitutes the visible top face. On both sides of the roll, adhesive tape rolls have what is called a side face, at which the backing material if used, the layer of adhesive and the release liner if used are flush. Industrially manufactured adhesive tapes are usually produced on wide coating lines and are slit in individual rolls so that the backing material if used, the layer of adhesive and the release liner if used are flush on both side faces. A problem which exists, however, is that over time the layer of adhesive may protrude slightly, causing the side face to become self-adhesive. As a result of this, dirt remains suspended on this face, and consequently the adhesive tape roll can no longer be placed, for example, on dusty substrates. Moreover, there may be problems in the course of subsequent processing or during peeling of the release liner; more particularly, there may be tearing of the release liner, which may block as a result of instances of damage to, and wetting of, the side faces by emerging adhesive.

In order to avoid these problems, adhesive tape rolls are protected on the side faces in the pack and during transport, prior to processing, by means of laterally mounted papers or films, in some cases coated with an adhesive-repellent material, so that in this way they are unable to develop a strong bonding force to the side face. However, applying side protection films or papers of this kind is laborious and expensive, since it must be adapted to different sizes of adhesive tape roll and must take place on both side faces of the adhesive tape roll. In a majority of cases, side protection films of this kind are still applied by hand, since automatic application systems are often unreliable or very laborious. A further factor is that, in the course of transit or storage, side protection films or papers of this kind may be displaced or may even fall off, and hence may bond the adhesive tape rolls to one another. Furthermore, in the event of severe escape of adhesive from the side face, and when unsiliconized or weakly siliconized protective films are used, the adhesive tape rolls may enter into such a strong adhesive bond with these protective films that the films can no longer be removed prior to processing, and the adhesive tape roll is difficult to process.

### SUMMARY OF THE INVENTION

It was an object of the invention, therefore, to avoid the above-described disadvantages of the prior art and to provide adhesive tape rolls with side protection in as simple a way as possible.

In order to achieve this object, the invention proposes providing the adhesive tape roll on at least one side face with a non-self-adhesive coating.

The invention accordingly provides a method for the side protection of rolls of adhesive tape, where a non-self-adhesive coating is applied to at least one side face of the adhesive tape roll. Suitable coating materials are varnishes, polymer dispersions, waxes or a powder suitable for forming coatings, such as talc, chalk, flour or powder comprising plastics. In addition the invention provides a roll of adhesive tape obtainable by the method of the invention. Preferred embodiments of the invention are defined in the description below and in the dependent claims.

### BRIEF DESCRIPTION OF THE FIGURE

The FIGURE shows a roll of adhesive tape provided on the side face with a non-self- adhesive coating.

### DETAILED DESCRIPTION

In accordance with the invention a non-self-adhesive coating is applied to the side face of the adhesive tape roll. This coating covers the entire side face, in other words, where used, the backing material with the layer of adhesive, and, where used, the release liner, with a flush finish. The coating is not self-adhesive, and therefore can be touched without sticking and leaving dirt adhering to it. Advantageously the coating is fragile, and so the roll of adhesive tape can be unwound and processed without any problems.

The self-adhesive tack or non-self-adhesive tack of the coating is measured on the side face in accordance with the standard ASTM D 2979-01, the diameter of the stainless steel probe being 32 mm and the constant approach rate to the sample being 10 mm/min. With such a measurement, in one preferred embodiment of the invention, the values for the self-adhesive tack are less than 9 N, more particularly less than 6 N, preferably less than 2 N, and with particular preference less than 1 N.

Suitable coating material comprises any varnishes, polymer dispersions, waxes or a powder suitable for forming coatings, such as talc, chalk, flour, or powders of plastics such as, for example, of polyacrylates, polystyrene, polyester, polyamide, polyurethane, polyvinyl chloride, polyolefins, polyvinyl acetate, polyisoprene or poly(iso)butylene, PTFE, and also copolymers of them, polysiloxane copolymers.

In one particularly preferred embodiment a varnish is the coating applied. This is more particularly an aqueous varnish, a solvent-borne varnish or a silicone varnish. The binder of the varnish may be employed in aqueous phase, in solvent or as a UV-crosslinking system with or without solvent. Besides this it is also possible to use a varnish which cures by means of beams of electrons, in other words by what is called electron-beam curing (EB curing). One preferred embodiment uses a varnish which cures by UV curing or electron-beam curing. For the application of the varnish it is possible to make use, for example, of a polymer dispersion which is capable of forming a surface-coating film. Examples of such are UV-crosslinking varnishes, solvent systems or aqueous varnishes, and powder coating materials may also be employed which, following application, are filmed by heat, or hotmelt systems which are applied at high temperatures and solidify on the side faces after curing, hence forming the non-adhesive protective layer. For the application of the coating, the starting material for the varnish is applied to the side face of the adhesive tape rolls by means, for example, of a roller system, foam system or in a spraying process, and is dried or cured. Drying may take place via supply of hot air. Coatings of this kind based on varnish or polymer dispersion offer the advantage that, as a function of the varnish or polymer used, they can be employed over a relatively wide temperature range and hence can also be stored at warm temperatures, e.g. 30° C. or 40° C.

In another preferred embodiment the coating is applied using a melted starting material, such as a melted wax or a melted polymer, which have no self-adhesive properties at room temperature. The starting material is applied using a roller system or spraying system, for example, and is cured by cooling, advantageously to room temperature. Suitable starting materials for the melting are waxes, thermoplastics, resins, hotmelts and hotmelt acrylates. This embodiment allows the side-protected adhesive tape rolls to be packed immediately.

The layer thickness of the side coating on the adhesive tape roll in the event of application of a varnish or a melted starting material is 1 to 1000 g/m², preferably 1.5 to 500 g/m², more preferably 2 to 200 g/m², most preferably 2 to 100 g/m². In another preferred embodiment the layer thickness is 5 to 100 g/m², more particularly 10 to 50 g/m². The thin layer thickness allows the adhesive tape to be unwound from the roll without problems.

In a further preferred embodiment of the invention the side face of the adhesive tape roll is provided uniformly with a powder. Powder which contacts the adhesive tape remains suspended and thus protects the side face of the adhesive tape roll, while loose, excess powder drops off and is removed, by blowing, suction or brushing, for example. Powders suitable for this embodiment include powders of plastics. Further suitable powders are precipitated or natural barium sulphate, titanium dioxide, calcium carbonate (e.g. chalk), kaolin, talc, magnesium hydroxide or aluminium hydroxide (latter hydroxides allow the fire class to be set), zinc oxide, zirconium salts, glass beads or hollow microbeads of all kinds.

The adhesive tape rolls to be protected are not subject to any restrictions. They may be adhesive tape rolls of all kinds, provided on one side or two sides with a self-adhesive layer (pressure-sensitive adhesive layer). Adhesive tape rolls of this kind are commercially customary and are available on the market in a multitude of versions, as a function of the desired application. The adhesive tape rolls in question are preferably rolls featuring double-sided adhesive tape. The protective coating is applied to at least one side face of the adhesive tape roll, preferably to both side faces.

The coating operation of the invention takes place after the adhesive tape rolls have been produced, advantageously before the adhesive tape rolls have been packed and/or after the slitting operation, in which, starting from a large roll, smaller adhesive tape rolls having a width and length conforming to the market requirements are unwound, slit off, and subsequently packaged.

The FIGURE shows an adhesive tape roll in which, in accordance with the invention, a non-self-adhesive coating A is applied on the side face shown.

Hence the invention, in a simple and industrially favourable way, allows adhesive tape rolls to be protected on their side faces. This allows the adhesive tape rolls to be processed even under difficult processing conditions, e.g. building sites, which are often very dusty or dirty.

The invention is elucidated with reference to the following example, which shows a preferred embodiment, without confining the invention thereto.

### EXAMPLE

The self-adhesive tack of the side face of an adhesive tape roll without a side coating was measured, and then the side face was coated laterally in accordance with the invention, and the self-adhesive tack was measured again. In each case the self-adhesive tack was measured in accordance with ASTM D 2979-01, the diameter of the stainless steel probe being 32 mm, and the rate of approach to the sample being at a constant 10 mm/min.

The adhesive tape roll under investigation was Sicrall from SIGA, a strongly adhering adhesive tape roll for the bonding of vapour diffusion retarders, which is protected on the side faces with laterally mounted protective films. The protective film was removed and the self-adhesive tack was measured on one side face as having a value of 40 N.

The adhesive tape roll is equipped on the side face with talc, by dusting and by allowing excess powder to drop off. A self-adhesive tack of only 0.4 N was measured.

1. Method for the side protection of rolls of adhesive tape, characterized in that a non-self-adhesive coating is applied to at least one side face of the adhesive tape roll.

2. Method according to claim 1, characterized in that the coating is formed using a material selected from varnish, a polymer dispersion, wax or a powder suitable for forming coatings.

3. Method according to claim 2, characterized in that varnish used is an aqueous varnish, a solvent-borne varnish, a silicone varnish or a varnish which cures by UV curing or electron-beam curing.

4. Method according to claim 3, characterized in that the coating is applied by means of a roller system or foam system or by spraying and is dried or cured.

5. Method according to claim 1, characterized in that the coating is formed using a melted starting material, more particularly a melted wax or polymer.

6. Method according to claim 5, characterized in that the melted starting material is applied by spraying and cured by cooling.

7. Method according to claim 1, characterized in that the thickness of the coating is 5 to 100 g/m², more particularly 10 to 50 g/m².

8. Method according to claim 1, characterized in that the thickness of the coating is 1 to 1000 g/m², more particularly 2 to 100 g/m².

9. Method according to claim 2, characterized in that powder used is talc, chalk, flour or a powder comprising plastic selected from polyacrylates, polystyrene, polyester, polyamide, polyurethane, polyvinyl chloride, polyolefins, polyvinyl acetate, polyisoprene, poly(iso)butylene, PTFE, copolymers of them or polysiloxane copolymers.

10. Method according to claim 9, characterized in that the powder is applied by spraying.

11. Method according to claim 1 characterized in that an adhesive tape roll with double-sidedly adhesive tape is used.

12. Roll of adhesive tape obtainable by a method according to claim 1.

13. Roll of adhesive tape according to claim 12, characterized in that the self-adhesive tack of the coating is less than 9 N, more particularly less than 6 N, preferably less than 2 N, and with particular preference less than 1 N, in each case when measured in accordance with ASTM D2979-01, the diameter of the stainless steel probe being 32 mm and the constant speed of approach to the sample being 10 mm/min.
